(19) United States
(12) Patent Application Publication
(10) Pub. No.: US 2006/0202824 A1
(43) Pub. Date: Sep. 14, 2006

(54) Electronic seal and method of shipping container tracking

(75) Inventors: Michael Glen Carroll, Fairfax, CA (US); David Edward Wyskiel, Livermore, CA (US); Richard Gianni, Healdsburg, CA (US)

Correspondence Address: EDWARD S. SHERMAN, ESQ., 3554 ROUND BARN BLVD., SUITE 303, SANTA ROSA, CA, 95403, US

(73) Assignee: Container Security Inc.

(21) Appl. No.: 11/347,135

(22) Filed: Feb. 2, 2006

Related U.S. Application Data
(60) Provisional application No. 60/650,002, filed on Feb. 4, 2005.
(60) Provisional application No. 60/721,250, filed on Sep. 28, 2005.

(51) Int. Cl. G08B 13/14

(52) U.S. Cl. 340/568.1

(57) ABSTRACT

An electronic device for the sealing of shipping containers is accessible through an RFID system controlled by a microprocessor having an internal memory. The device consists of a small case with a tamper and spoof proof security cable. One end of the cable is permanently attached to the case while the other end is threaded across the center door joint and around the two inner vertical locking rods of the container. The loose end is then inserted and locked into a port on the case, thereby activating the microprocessor. Attempts to access or enter the container through the rear doors will result in severing the cable, causing the time of this event to be logged in the memory of the electronic seal device. A separate electronic reader will access the logged memory of the device, and then transmit the logged data to a central database. The device has a unique and invariant electronic identification number that will be transmitted to a reader on demand. In addition, the case will have that same number embossed on the case cover as well as a printed bar code. The device also contains a real time clock that is activated at the time of initial activation.

### CROSS REFERENCE TO RELATED APPLICATIONS

The present application claims priority to the U.S. provisional application having Ser. No. 60/650,002 entitled “Electronic Seal and Method of Shipping Container Tracking”, which was filed on Feb. 4, 2005, which is incorporated herein by reference.

The present application also claims priority to the U.S. provisional application having Ser. No. 60/721,250 entitled “Electronic Seal and Method of Shipping Container Tracking”, which was filed on Sep. 28, 2005, which is incorporated herein by reference.

### BACKGROUND OF INVENTION

The present invention relates to electronics locks and seals and in particular to locks having a data logging capability for use in sealing containers.

Non-fungible goods are routinely transported in what are called intermodal shipping containers. The containers are uniform in dimension to facilitate packing and transfer, being sized for convenient transport on rail cars and flat bed trucks. These shipping containers are generally secured by a pair of locking doors that extend the height of the container, disposed on the narrowest vertical side.

Theft and tampering with such shipping containers is a significant source of lost revenue to shippers and merchants. Moreover, such containers, if not properly sealed and inspected, pose the risk for smuggling contraband across national borders.

While the doors to such containers accept multiple padlocks, this merely deters rather than eliminates theft and pilferage. Given enough time, a thief can remove pad locks and even remove and replace latch mechanisms. It being desirable to at least detect the unauthorized entry into shipping containers during shipment and storage. Such containers are routinely tagged with numbered metal seals, which generally have a wire ring that runs through the lock hasp. Thus, opening the container breaks the numbered metal seal. However, the containers still require visual inspection to determine if the seals are broken.

At the other extreme, high value and dangerous cargoes can be shipped in containers that utilize electronic seals that routinely monitor and transmit the containers location and status, using global satellite positioning systems (GPS) and satellite radio transceivers. However, as such devices are extremely expensive they cannot be used routinely on all shipping containers.

Other forms of electronic seal devices are commercially available and are programmable and which transmit information that is programmed, such as tagging identification serial numbers and other information as desired. The integrity of the seal is detected and is available for transmission. This is referred to as radio frequency identification (RFID) which is well known in the art. Generally, an active RFID tag will have a radio frequency (RF) transmitter, an RF receiver, a baseband modulator, and a memory. The memory retains the digital code manifesting the identification number. The baseband modulator extracts the digital code representing the identification number as a modulated signal, which is applied to the RF transmitter. The RF receiver receives interrogation and control signals which manifest a request for the identification number, and/or other information. Such systems provide security tagging for high value merchandise as it is transferred from the manufacturer to the consumer. Such active electronic seals have been used to tag and track humans and vehicles, such as trucks and their cargo containers.

One such effort to provide an electronic seal is described in U.S. Pat. Nos. 6,747,558, and 6,765,484, which are incorporated herein by reference. The device comprises a bolt mechanism which, when tampered with disturbs a magnetic field generated by the device. Sensing the disruption in the magnetic field, the electronic device transmit wireless signals, which depending on the strength of the RFID transmitter are detectable within a proximity of about 100 feet (30 meters). Other electronic seals are described in U.S. Pat. Nos. 6,281,793; 6,069,563 and 6,265,973, which are incorporated herein by reference.

While such devices permit remote or automatic inspection of shipping containers they are not yet in routine use. Such devices even when properly deployed will not detect all types of breaking and into a shipping container. As these devices are mounted externally, they are sensitive to damage from the environment and vibration. The ability to detect the time and location of entry for pilferage is of great importance in both allocating responsibility for the loss, as well as taking future preventive measures. In many cases, the device is used like a metal seal or padlock on the existing hasp, and hence will be destroyed or lost, such as when the container is broken into, negating automated inspection and tracking the location of the pilferage, precluding the expected benefits of electronic tracking.

Thus, it has come to be appreciated by the inventors that the shipping industry has a need for electronic seals that are less expensive than current electronic seals, yet more robust to provide more security than the metal wire and other physical seals currently used to tag shipping containers.

### SUMMARY OF INVENTION

In the present invention, one objective is achieved by providing a compact electronic seal device adapted to be secured to the handle of a shipping container. The electronic seal device utilizes an external connecting cable that makes a first connection to the device at a first end. The opposite free end is then threaded across the center door joint and around the two center vertical locking rods, before insertion and locking into the device at a second connection point.

The electronic seal device further comprises an active RFID transceiver, a real time monitoring clock, internal memory, power supply and antenna in communication with a microprocessor means to control active RFID transceiver in response to external signals. The microprocessor means monitors the resistance of the circuit formed by the external connecting cable for logging the time of a change in resistance of the cable to the internal memory. The door of the shipping container cannot be opened without interrupting or modifying the resistance of the external cable, the device is able to log both authorized and unauthorized entry into the container.

Interrogation of the electronic seal device with a reader enables container tracking. The device is intended to be of sufficiently low cost for single use, and hence is more secure to spoofing or cloning than multiple use devices. The method of mounting and connecting the locking cable prevents damage from vibration. Running the cable around both locking rods requires that the cable be cut even if the handle hub is drilled out and replaced. The electronic seal will remain attached to the container and the tamper event will be logged

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a perspective view of the device.

FIG. 2 is a side elevation of the device of FIG. 1.

FIG. 3 is an electrical schematic of the circuitry in the device of FIG. 1.

FIG. 4 is a perspective view of the device installed on a shipping container.

FIG. 5 is a plan view of an alternative embodiment of the device.

FIG. 6 is cross section through the alternative device in FIG. 5. shown in plan view as installed on a locking bar.

FIG. 7A is a perspective view of an alternative embodiment of the invention.

FIGS. 7B and 7C are plan views of the device of FIG. 7A installed on a locking rod.

FIG. 8A is a schematic sectional view of another alternative embodiment of the invention in which a socket insert is in place. FIG. 8B is the section of FIG. 8A in which the socket insert has been removed and the locking cable has been inserted in the place thereof.

### DETAILED DESCRIPTION

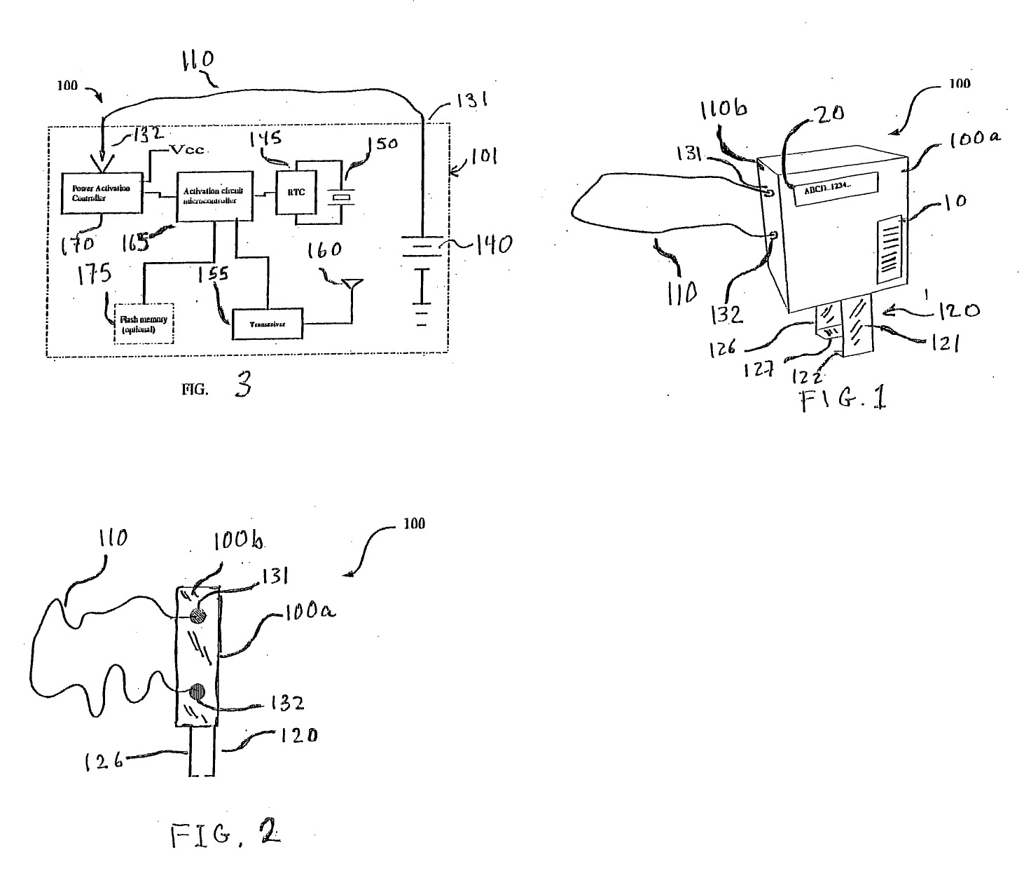

Referring to FIGS. 1 through 8, wherein like reference numerals refer to like components in the various views, there is illustrated therein a new and improved electronic seal device, generally denominated 100 herein.

In accordance with the present invention, FIG. 1 illustrates a first embodiment of the electronic seal device 100. The device 100 is generally shaped as a box like housing 105 having a front face 100a, and a side face 100b. A security cable 110 extends from the side face 100b at cable output port 131 and enters device 100 at cable locking port 132, also disposed on side face 100b. The front face 100a includes one or more, and preferably two forms of unique device identifying information (ID), in an alphanumeric format 10 and the corresponding information in bar code format 20.

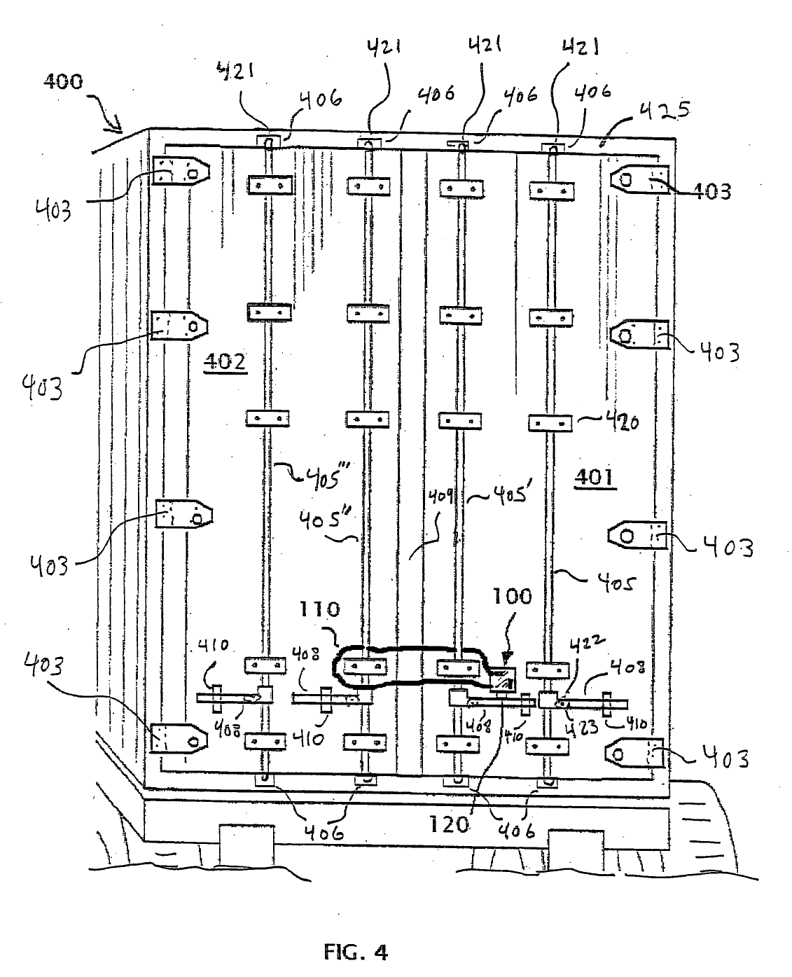

FIG. 4 illustrates one embodiment for installing the electronic seal device 100 on a shipping container, as affixed to handle 408 by clamp 120. The shipping container 400 has double doors 401 and 402 mounted on the end on hinges 403, such that the doors open from the centerline 409 of the shipping container 400. Each door is locked to the frame 425 of the shipping container 400 by a pair of vertical locking rods 405. The locking rods 405 terminate in cams 421 that engage lock keepers 406 disposed on the top and bottom of the frame of shipping container 400 for rotary motion there within. The locking rods 405 are maintained in place and rotate freely within bearing brackets 420. The cam 421 at the ends of each locking rod 405 include cooperatively disengages the lock keeper 406 when the rod is rotated out of the locked position. Thus, entry to the shipping container 400 requires the release of locking rods 405 by rotating handles 408, which are disposed at right angle to the locking rod axis. When the handles 408 are flush with doors 401 and 402, the cams 421 at the ends of the locking rods 405 are engaged into lock keepers 406, and the door cannot be opened. However, when the handles are rotated by, for example 90 degrees or orthogonal to the plane of each door, the locking rods 405 are rotated 90 degrees such that the cam 421 disengages the lock keeper 406 and the ends of the locking rods are released. Thereafter, the doors 401 and 402 are swung open via hinges 403. Typically, each handle 408 is secured to the adjacent door by the latch mechanism 410, the latch having a bore that accepts a locking bolt. Frequently, the handle 408 is attached to the locking rod 405 via a rivet 423 that joins a handle hub 422 to the handle. The handle hub 422 graspingly surrounds the locking rod 405 at one side while its opposite side is attached to the handle via the rivet 423.

The electronic seal device 100 is preferably contained within a housing 105 having a thickness of about 1″, or thinner than at least one of the handle and locking rod. In one embodiment, device 100 is mounted onto the handle 408 of the shipping container via clamp mechanism or bracket 120. The bracket 120 is intended to position the electronic seal device 100 on the handle 408 between the locking rod 405 and the latch mechanism 410. In the embodiment shown in FIG. 1, the clamp mechanism 120 is comprised of a pair of prongs, front prong 121 and rear prong 126. Each prong has a lower ledge or vertical surface 122 for prong 121, and 127 for prong 126. While device 100 can be affixed to either a handle on the right or left door, it is preferably disposed with the cable 110 exiting toward the centerline of the container 409, where doors 401 and 402 meet and overlap. It should be noted as shown in FIG. 2, that the front edge of the mounting clamp 120 is positioned at least flush, if not behind, front face 100a. Accordingly, the remainder of the device 100 will be behind the handle or other mounting structure on the container and thus protected without interfering with the operation of the handle 408.

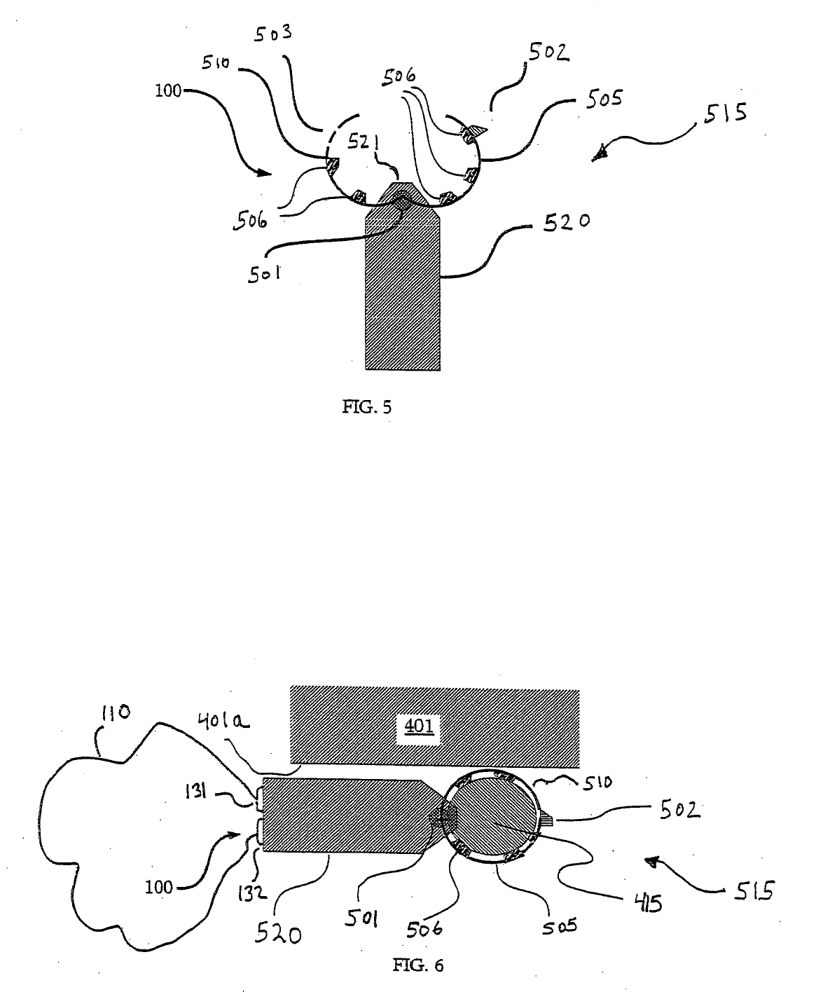

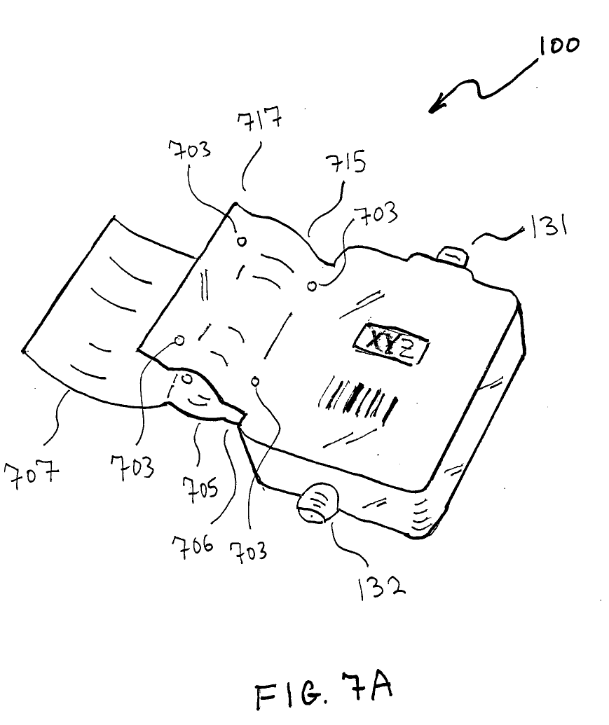

In other embodiments, the device 100 may optionally be attached to another portion of the container, such as via the locking rod or door face in case the handle is removed during theft. For example, as shown in FIGS. 5 and 6, an alternative embodiment of the electronic seal device 100 is connected to the locking rod 405. Referring to the plan view in FIG. 5, housing 105 includes a tubular clamp assembly 515 connected to one side of the housing, preferably apex 521, at hinge 501. The tubular clamp assembly 515 comprises a left 510 and right tubular 515 shell, each connected to or near a common axis with hinge 501. The right tubular shell includes a detent 502 disposed distal from the hinge connection 501. Left tubular shell has an aperture 503 disposed distal from hinge connection 501 which engages detent 502 when the left and right tubular shells surround the locking rod 415, as shown in FIG. 6. As the inner circumference of the tubular clamp assembly is preferably lined either rubber pads 506, or alternatively a strip of rubber, latching the left and right tubular shells together via detent 502 secures device 100 to the locking rod 415 in a fixed position. Further, as shown in the installed position in FIG. 6, device 100 is flush with the outer face 415a of door 415, and thus protected from blunt impact by the locking rod 415.

It should be appreciated that FIGS. 4 and 5 illustrate just one preferred embodiment of a mounting mechanism for the electronic seal device, as they include a latchable mounting device, enabling the simple and efficient installation, as well as removal after the latch (or detent mechanism in this non-limiting example) is released. The latching mechanism secures the device to the container, minimizing the chance of loss or damage during shipment.

Accordingly, the device will generally be retained or attached to the shipping container even if the external cable is cut. As the device does not extend beyond the locking bar mechanism of the shipping container it is more durable with respect to vibration and damage from contact with adjacent shipping containers or equipment. Use of the compact electronic seal device is compatible with current business practice of deploying a uniquely numbered mechanical seal on shipping containers.

While the external cable 110 of the electronic seal device 100 is also optionally threaded into latch 410, the preferred mode of use is to thread the free end of the cable across the center door joint 409 and around the two center vertical locking rods 405′ and 405″ on adjacent doors 401 and 402. The loose or free end of cable 132 is then inserted and locked into port 132 on the side 100b of the case 105, thereby activating the electronic circuit illustrated in FIG. 3. The electronic seal device, as will be further described with respect to FIG. 3, also contains a real time clock that is activated at the time of this initial activation. The initial entry of the cable into cable locking port 132 initializes the electronic clock, logging the sealing of the container as the first event.

Accordingly, cable 110 has a sufficient length to span across the center locking rods on adjacent door, which is generally at least about 3′ (910 mm). Attempts to access or enter the container through the rear doors will result in severing the cable, this event and the time of its occurrence will logged in the memory of the electronic seal device 100. However, the device 100 will be retained on the container after the cable 110 is cut. Other illicit means of gaining entry to the container, that avoid cutting cable 110, would require physical destruction or alteration of the locking bars and mechanism, indicating that the contents have been pilfered.

The use of a high resistance cable is a preferred means of making the device “spoof proof”. That is, the detection of the deliberate cutting of the cable cannot circumvented by connecting a parallel circuit before the cut is made, as the device would sense and react to, that is at least log, the change in resistance. Further, trying to make such a parallel circuit at the same instant as breaking the circuit formed by the security cable would, in addition to the near impossible timing requirement, also require that the original cable impedance be matched.

It should be apparent that numerous alternative means are available to provide a spoof proof external cable, such as fiber optic cables used in prior art electronic seal devices. The unique ID of each such device 100 is further protection from spoofing, as both the container ID and the device ID are intended to be recorded in a central database.

FIG. 3 illustrates the electronic circuit 101 formed when distal end of locking cable 100 is inserted into locking port 132. The cable is energized by battery 140. Insertion of the free end of cable 110 into port 132 activates the microprocessor means to detect, log and communicate the status of the electrical connection formed by cable 110. The microprocessor then refers to the real time clock 145, having crystal oscillator 150 to determine the time of circuit activation. Next, the power activation controller 170 will communicate through activation circuit microcontroller 165, to record the initial resistance of cable 110 and the time of activation as a log entry into either the microcontroller 165 or optional flash memory 175. Completing circuit 101 also initiates the tracking of the resistance of the cable 131, causing the subsequent time logging of events where cable 110 is either disconnected or undergoes a change in resistance. That is, the microprocessor means controls the active RFID transceiver to communicate the status of the logged events, i.e. the time at which a change in resistance of the cable has occurred.

The electronic seal device 100 has a unique and invariant electronic identification number that will be transmitted to an electronic reader device on demand. The circuit is preprogrammed with the unique ID number that is identical to that printed, or preferably embossed, on the external case of the seal in an alphanumeric format 20 and bar code format 10 as illustrated in FIG. 1.

Thus, after such initial installation, an RFID reader/writer device is then used to program the shipping container ID, generally marked or painted on the outside of each shipping container, into the memory or log of the electronic seal device 100. The time, event and data log in the memory of the device 100 will be accessed by the same or possibly separate electronic reader and the data transmitted to a central database as the shipping container is inspected at various transit points. The central database can be updated whenever sealed containers are re-interrogated by hand held RFID readers or pass through fixed RFID scanners, that might be positioned in a port, at customs, along a rail line and the like.

The RFID Antenna function for reception and transmission of the data log can occur through a single shared antenna, such as 160 connected to transceiver 155, or the transceiver can use two dedicated antennas, one for reception and another for transmission. Likewise, the function of transmission and reception of transceiver can be split into two discrete components that share a single antenna, or utilize separate antennas can be shared between. The transmission and reception of data for communication with a reader device may occur on the same frequency, or on different frequencies. Such RFID readers/writers are described in U.S. Pat. Nos. 6,765,484, and 6,002,344, which are incorporated herein by reference.

It should be appreciated that the use of the electronic seal device 100 is particularly compatible with current business practice of deploying uniquely numbered mechanical seals on shipping containers; as such the device is intended for single use. Thus, in shipping ports and locations not equipped with RFID readers, the ID code can be recorded in the usual manifest. Further, such a single use device is more secure to spoofing or cloning than multiple use devices, and may utilize multiple counterfeit and security measures to preclude its imitation.

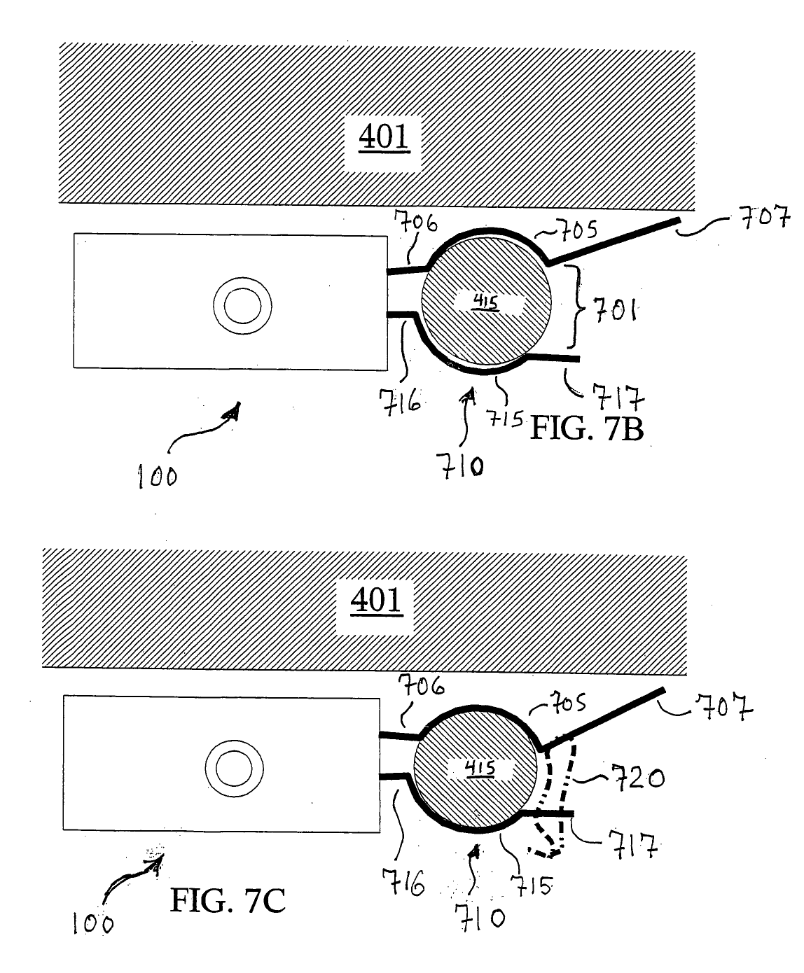

The method of mounting and connecting the locking cable is intended to prevent damage from vibration as well as contact of the door side of the container with other objects. However, the method and structure for mounting the electronic seal device 100 to the handle or other part of a shipping container may be varied according to the handle structure and user preferences, with a balance being struck between the ease of installation and the robust thereof from vibration, accidental contact and pilferage. FIG. 7A illustrates such an alternative embodiment of the invention in which the electronic seal device 100 is connected to the locking rod 415 via a different tubular clamp assembly 710. The tubular clamp assembly 710 is attached to the side of device 100 and consists primarily of two different partial tubular sections, 705 and 715. As both partial tubular sections 705 and 715 are individually attached to the side of the device 100 by short spacer strips 706 and 716 respectively then can flex open at gap 701 to fit around the tubular locking rod 415. Thus, when the partial tubular sections 705 and 715 are released they grasp locking rod 415. Partial tubular section 705 terminates at the end most distal from device 100 with a long wing section 707. The long wing portion tilts backward from the device 100 toward door 401 and thus prevents rotation of device 100 about locking bar 415. Partial tubular section 705 terminates at the end most distal from device 100 with a short wing portion 717. The short wing section 717 provides a means to grasp and open gap 701 when the device 100 is removed from the locking rod 415.

Each of the short spacer strips 706 and 716 has holes 703. Additionally a pair of vertically spaced apart holes attached to the each of the short wing portion 717 and the long wing portion 707. As shown in FIG. 7C, to the extent that a particular locking rod 415 has such a narrow diameter that it would not be held firmly by partial tubular shell sections 705 and 715, the holes provide for the insertion, wrapping and attachment of self locking ties 720 to draw the wing portions 707 and 717 of the partial tubular section 705 and 715 together such that the device 100 is tightly secured to the locking rod 415. In an alternative embodiment the self locking ties 703 (or an alternative wire fixture that self locks on tightening) can be pre-attached to either of the wing portions 705 or 715 or the holes 703 therein.

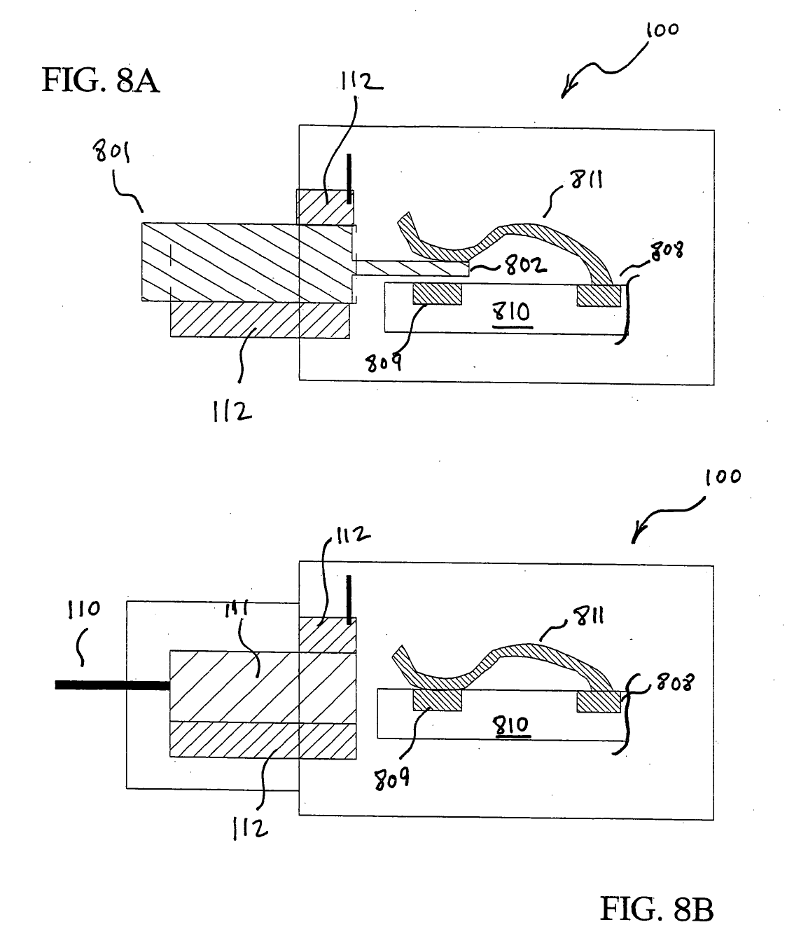

FIG. 8 represents an alternative embodiment for starting the clock 415 when the locking cable 110 is inserted. FIG. 8A is a schematic cross-sectional view through device 100 with socket insert 801 in place. The socket insert 801 prevents the insertion of the free end or plug end 111 of the locking cable from being inserted into the device 100 until it is ready to be installed. The socket insert 801 has a thin strip of dielectric material at the end portion 802. The internal timing and event logging circuits are printed on circuit board 810 (of which a portion is shown in this diagram) and include an S-shaped leaf spring 811 with a fixed contact 809 to the timing circuit and a variable contact 808 with another portion of the timing circuit. In this embodiment, the socket 112 of the sensing circuit is an annulus, thus permitting the tip 802 of socket insert 801 to reach to the variable contact 808 on circuit board 810. The end portion 802 of socket insert 801 blocks the end of leaf spring 811 from reaching variable contact 809, causing the timing circuit to remain open until socket insert 801 is removed. Thus, the timing circuit cannot be activated until socket insert 801 is removed, just before cable 110 is inserted into device 100. In FIG. 8B the socket insert 801 has been removed and the plug 111 on the end locking cable 110 has been inserted in its place, into socket 112, thus completing the sensing circuit.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. An electronic sealing device for container security that comprises:
a) a housing having enclosed therein;
i) an electronic real time clock,
ii) an electronic internal memory
iii) an active RFID transceiver,
iv) an antenna,
v) a microprocessor for controlling external communication via said active RFID transceiver to read and write to said internal memory, and having a first and second port,
vi) a power supply for said microprocessor, real time clock and internal memory,
b) a high resistance cable connected to said microprocessor at the first port and connectable at the second port,
c) wherein said microprocessor is responsive to log the time of changes in the resistance of said high resistance cable, as measured between the first and second port, into said internal memory.

2. The electronic sealing device of claim 1 wherein said high resistance cable has a length of a least about 3 feet.

3. The electronic sealing device of claim 1 further comprising a unique identification code in said internal memory.

4. The electronic sealing device of claim 3 wherein the unique identification code is marked in at least one of alphanumeric and bar code format on the outside of said housing.

5. The electronic sealing device of claim 2 wherein the unique identification code is marked in both alphanumeric and bar code format on the outside of said housing.

6. The electronic sealing device of claim 4 wherein the alphanumeric letters or numbers have a height of at least about 0.25 inches.

7. The electronic sealing device of claim 1 where the electronic seal device further comprises a mounting bracket that latchably engages at least one of a handle or rod fixture on a shipping container.

8. The electronic sealing device of claim 1 further comprising means for latchable engagement to a handle or rod of a shipping container.

9. A process for tracking containers and logging tamper or opening events of a shipping container thereof, the process comprising the steps of:
a) providing an internally powered electronic seal device having a microprocessor that controls an RFID transceiver, an internal memory, and an electronic clock, the microprocessor being in communication with an external high resistance cable at a first port and having a second port to receive the opposite end of the high resistance cable,
b) writing a unique electronic seal device ID code to the internal memory of the microprocessor,
c) permanently marking the unique ID code on the outside of the electronic seal device,
d) mounting the electronic seal device on the shipping container to be at least one of tracked and protected,
e) physically sealing the container by threading the high resistance cable across the center door joint and around the two vertical locking rods and connecting it into the second port thereby activating the microprocessor circuit,

10. The method of claim 8 further comprising the steps of:
a) communicating through the RFID transceiver to write a unique container ID to the internal memory,
b) detecting an opening or tamper events by measuring a change in impedance of the high resistance cable,
c) writing the time and occurrence of the opening or tamper event to the internal memory,
d) communicating through the RFID transceiver to access the internal memory.

11. The method of claim 8 wherein said step of permanently marking includes providing at least one of an alphanumeric mark and a bar code mark.

12. The method of claim 8 wherein step of permanently marking is by embossing.

13. The method of claim 8 wherein said step of permanently marking is by printing.

14. The method of claim 8 wherein said step of mounting the electronic seal device comprises latchable mounting to the shipping container.

15. The method of claim 8 wherein the real time clock is activated by the attachment of the high resistance cable to the second port.

16. An electronic sealing device for container security that comprises:
a) a housing having enclosed therein;
i) an electronic real time clock,
ii) an electronic internal memory
iii) an active RFID transceiver,
iv) an antenna,
v) a microprocessor for controlling external communication via said active RFID transceiver to read and write to said internal memory, and having a first and second port,
vi) a power supply for said microprocessor, real time clock and internal memory,
vii) means for latchable engagement to a handle or rod of a shipping container.

17. The electronic sealing device of claim 16 wherein the means for latchable engagement further comprises a mounting bracket that latchably engages at least one of a handle or rod fixture on a shipping container.

18. The electronic sealing device of claim 16 further comprising a unique identification code in said internal memory.

19. The electronic sealing device of claim 18 wherein the unique identification code is marked in at least one of alphanumeric and bar code format on the outside of said housing.

20. The electronic sealing device of claim 17 wherein the mounting bracket comprises means for attachment to a rod fixture of a shipping container, said attachment means including an extended portion to prevent rotation about the rod after attachment.
